(19) United States
(12) Patent Application Publication
(10) Pub. No.: US 2026/0070245 A1
(43) Pub. Date: Mar. 12, 2026

(54) SHAVING APPARATUS

(71) Applicant: The Gillette Company LLC, Boston, MA (US)

(72) Inventors: Robert Andrew Kearney, Reading (GB); Hannah Bryony Roberts, Ferndown (GB); Matthias Gester, Farnborough (GB); Rachel Alice Gibson, Reading (GB)

(21) Appl. No.: 19/320,144

(22) Filed: Sep. 5, 2025

Related U.S. Application Data
(60) Provisional application No. 63/691,666, filed on Sep. 6, 2024.

(51) Int. Cl. B26B 21/40; B26B 21/52

(52) U.S. Cl. CPC B26B 21/4006; B26B 21/521

(57) ABSTRACT

The present invention is directed to a shaving apparatus. The shaving apparatus includes a flexible substrate and a plurality of treatment sheets, each treatment sheet comprising at least one first aperture, at least one first aperture comprising cutting edges, wherein the plurality of treatments sheets are secured to said flexible substrate. The flexible substrate allows the treatment sheets to move in response to a force applied during hair removal.

### FIELD OF THE INVENTION

The present disclosure relates generally to shaving apparatuses for hair removal and more specifically to shaving apparatuses for body hair removal.

### BACKGROUND OF THE INVENTION

The discussion of shortcomings and needs existing in the field prior to the present disclosure is in no way an admission that such shortcomings and needs were recognized by those skilled in the art prior to the present disclosure.

Hairs on the body grow in many directions, with hairs located next to each other or in close proximity to one another, often growing in very different directions. Today's wet shave razors require the hairs to be approached by the blade in a particular direction to ensure that they are cut effectively. Hairs which are cut by a blade travelling in a direction opposite to the direction of growth, often termed up-strokes, are cut closer and more consistently than hairs which are cut by a blade travelling perpendicular to the direction of hair growth. To compensate for this shortcoming, it is necessary for the user to take lots of strokes in multiple directions to ensure that all of the hairs are removed effectively. A further shortcoming of today's wet shave razors is that they must only be used to perform strokes which are perpendicular with the direction of the blade edge to ensure that there is no slicing motion of the blade relative to the skin, since this can result in nicks and cuts. When shaving areas of the body which are difficult to reach, such as the back, it can be particularly difficult to ensure that there is no lateral movement of the blade relative to the skin. This results in the user having to expend significant amounts of energy to try to maintain linear strokes or having to ask a third party to help them to remove the hair or for the user to compromise on the safety of their shave.

When shaving areas that are difficult to reach, users may not be confident that they shaved all the necessary areas where they want to remove hair from. This problem may be exacerbated by the various advancements in razor technology that have almost eliminated any blade feel by the user during shaving. Thus, users may not only be unable to see where they are shaving, but they may not be able to feel where they may have already shaved.

In addition to challenges with reach and visibility when removing hair from certain parts of the body, the complex contours of the body can also make hair removal challenging. Whilst many shaving devices comprise one or more pivots to enable better contact between the skin and the blades over these contours, challenges still exist with efficient and effective hair removal over complex contours which vary in multiple directions, e.g. the knee, underarm or intimate region where contours are tight and shaving devices are too rigid and big to fit. This means that the user is required to still take many strokes in different directions, even when the shaving device is able to pivot.

Therefore, a need has been identified for a hair removal device to improve one or more of the problems above.

### SUMMARY OF THE INVENTION

The present invention is directed to a shaving apparatus. The shaving apparatus comprises a flexible substrate having a top surface and a bottom surface. A plurality of treatment sheets are secured to the flexible substrate. Each treatment sheet comprises at least one first aperture. Although connected by either a flexible substrate in the form of a skeleton structure, a skeleton structure that is not flexible, a flexible substrate, or a combination thereof, each treatment sheet may bend independently from the other treatment sheets on the shaving apparatus. At least one of said first apertures comprising cutting edges. The treatment sheets comprise an upper surface, a lower surface and a perimeter. A handle may be secured to the bottom surface of the flexible substrate. Additionally, the handle may be molded as part of the flexible substrate so that they are one piece. The flexible substrate and handle allow the treatment sheets to move in response to a force applied during hair removal.

The shaving apparatus may comprise a support sheet joined to a lower surface of the treatment sheet, an upper surface of the treatment sheet, or any combination thereof.

The support sheet of the shaving apparatus preferably does not obstruct the plurality of the first apertures.

The support sheet may be comprised of a solid material which is comprised of a metal, ceramic, thermoplastic, thermoset, or elastomeric polymer, and mixtures or composites thereof.

The support sheet may be joined to the treatment sheet by a support material. The support material may be an adhesive, a varnish, an ink, or any combination thereof.

The support sheet may comprise a plurality of second apertures. The plurality of second apertures are aligned with each of the plurality of first apertures.

The treatment sheet may be secured directly or indirectly to the flexible substrate.

The shaving apparatus may comprise a support ring secured to each treatment sheet with the support ring being secured to the flexible substrate.

The said support ring may be comprised of a thermoplastic, thermoset, elastomeric polymer, or any combination thereof.

The support ring may be comprised of a flattened ring, a solid tube, a hollow tube, or any portions or combinations thereof.

The flexible substrate may be comprised of a material that exhibits preferred properties in various conditions such as, for example, when dry versus when wet or exposed to steam. “Wet” as used herein means that the shaving apparatus has been exposed to water having a minimum temperature of 20 degrees Celsius for a minimum duration of at least 1 minute. Additional exposure in terms of duration or exposure at temperatures greater than 20 degrees Celsius are contemplated within the meaning of “wet”. Without being bound by theory, it is believed that having a support sheet capable of surviving impact when dry while potentially having increased flexibility when wet or, additionally, when in use, allows the user both control and the ability to get a closer shave. The flexible substrate may exhibit an average stiffness (g/mm) when dry or under ambient temperature of greater than 1 g/mm such as, for example, between 5 g/mm and 25 g/mm, such as, 10 g/mm, 15 g/mm, 20 g/mm, 21 g/mm, 22 g/mm, 23 g/mm or 24 g/mm. The flexible substrate may further exhibit an average stiffness of less than 20 g/mm when wet. As shown in FIG. 7A-C, depending on the temperature of the water and the composition of the flexible substrate, the shaving apparatus may exhibit an average stiffness of between 5 g/mm and 15 g/mm when in use, such as for example, 11 g/mm, 12 g/mm, 13 g/mm, and 14 g/mm. For example, as shown in FIG. 7, after 1 minute of submersion at 45 Celsius, the shaving apparatus exhibits an average stiffness of less than 15 g/mm.

The flexible substrate stiffness may exhibit a difference or delta between dry and wet of between 0 g/mm and 10 g/mm, preferably between 0 g/mm and 5 g/mm, such as, for example, 1 g/mm, 2 g/mm, 3 g/mm, 4 g/mm and 5 g/mm. Without being bound by theory it is believed that a delta greater than 10 g/mm represents an undesirable distance from the optimal in use range of 10 to 15 g/mm average stiffness. If a delta between dry and wet or in use is too great, the user is made to take additional steps to have the shaving apparatus enter the in use range. This is because the average stiffness is a function of temperature and time. As shown in FIG. 7A, by immersing at a higher temperature for a longer period of time (10 minutes versus 1 minute) the average stiffness can be lowered. As such, a large delta means that the optimal in use range may not be reached in a shower for a longer period of time delaying use of the shaving apparatus.

The handle may be comprised of a flexible material. The handle may be comprised of a rigid material.

The flexible substrate may be comprised of a fabric, rubber, silicone, solid metal, linked metal such as chainmail, foams, sponges, polymer, or any combination thereof. The flexible substrate may be a skeleton structure connecting the treatment sheets or may be a layer that contains the treatment sheets. As shown in FIG. 1, the flexible substrate may form the outer perimeter of the shape. As used herein, flexible means that the substrate can be deformed, bent, or elongated at temperatures between 25 degrees Celsius to 60 degrees Celsius without breaking.

### BRIEF DESCRIPTION OF DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is a perspective view of the shaving apparatus of the present invention.

FIG. 2 is another perspective view of the shaving apparatus of the present invention.

FIG. 3 is an exploded view of the treatment units of the present invention.

FIGS. 4A-4C are cross section views of treatment sheets and support rings.

FIGS. 5A-5F depict perspective views of various embodiments of a treatment unit of the present invention.

FIG. 6 is a perspective view of another embodiment of a treatment sheet of the present invention.

FIG. 7A-7C represents average stiffness data under different conditions for different flexible substrates.

FIG. 8 is a perspective view of an alternative embodiment of the shaving apparatus of the present invention.

FIGS. 9A-9B is another perspective view of the shaving apparatus of FIG. 8.

FIG. 10A-10C are alternative embodiments of the shaving apparatus.

FIG. 11A-11B shows alternative embodiments of the shaving apparatus.

FIGS. 12A-12D show alternative embodiments of the shaving apparatus.

FIG. 13 shows an alternative embodiment of the shaving apparatus.

FIG. 14 shows an alternative embodiment of the shaving apparatus.

FIG. 15 shows an alternative embodiment of the shaving apparatus.

FIG. 16 shows an alternative embodiment of the shaving apparatus.

FIG. 17A-17E shows measurement points for different potential geometries in relation to the test method described herein.

FIG. 18A-18G shows different views of an embodiment of the shaving apparatus.

### DETAILED DESCRIPTION OF THE INVENTION

In the present invention a shaving apparatus comprises a flexible substrate having a top surface and a bottom surface. A plurality of treatment sheets are secured to the flexible substrate. Each treatment sheet comprises at least one first aperture and preferably a plurality of first apertures. Each of said first apertures comprise cutting edges. The treatment sheets comprise an upper surface, a lower surface and a perimeter. A handle is secured to the bottom surface of the flexible substrate. The flexible substrate and handle allow the treatment sheets to move both independently and as a group in response to a force applied during hair removal.

The cutting edges of the apertures in the treatment sheet may be coplanar, e.g. in the same plane or out of plane. Preferably, the cutting edges do not protrude or extend beyond an upper or lower surface of the treatment unit. Durable cutting edges can be produced from materials like ceramic or crystals like silicon, composites, metals, sapphire, diamond or combinations thereof. These materials are not ductile like metal and often are brittle, and thus they cannot be formed into e.g., a domed or convex shape, but rather are planar sheets. This type of planar treatment surface increases the treatment efficiency such as the removal of hair or dermaplaning of skin on extended flat surfaces of skin such as legs, chest and back.

The term “treatment sheet” in the shaving apparatus of the present invention refers to a planar sheet comprising a plurality of apertures. The periphery or perimeter of the apertures comprise cutting edges, used for removing hair.

The treatment sheet is desirably flat. A “flat” material generally has planar surfaces without protrusions or indentations. As used herein, “flat” and “planar” can be used interchangeably.

The treatment sheet is also desirably rigid. A “rigid” material signifies that the material is not flexible and cannot be easily bent.

The treatment sheet of the present invention is desirably comprised of a solid, non-corroding material. The treatment sheet can be comprised of amorphous materials such as glass, crystalline materials such as silicon, diamond, sapphire, polycrystalline materials such as silicon, ceramic, or metals (e.g., steel), or any combination thereof. These materials can be shaped into rigid planar treatment sheets with apertures. Despite their rigidity, these materials can be fairly brittle. A “brittle” material is a material that generally fractures under load with little elastic or plastic deformation. The treatment sheet comprised of these materials, such as silicon and diamond, could shatter or break into pieces if the personal care product is dropped, if it is contacted with force, or takes the impact of a large force. Accordingly, the present invention increases the stability of the treatment sheet by providing a support structure. The support structure can be comprised of one or more elements. Preferably, the treatment sheet substrate is comprised of a silicon material and the cutting edges are comprised of a diamond material.

A “treatment unit” of the present invention comprises a treatment sheet and at least one other support structure or material. The support structure may itself be comprised of one or more types of structures or materials and serves to support the treatment sheet providing stability, by reducing impact to the treatment sheet if an external force is applied to the treatment sheet or any component of the personal care product and by reducing damage to the treatment sheet and thus preventing injury to the consumer if the personal care product is dropped and fragments of the treatment sheet separate from the treatment unit.

The “support structure” as used herein, signifies a structure disposed either beneath the treatment sheet, (e.g., joined to the lower surface of the treatment sheet, as will be described below), around perimeter portions of the treatment sheet (e.g., in the form of a ring), or both.

The “support structure” may comprise a support material such as a substance or material that is comprised of a fluid and cures or dries or hardens to form a solid material. Such materials can be one or more of the following: adhesive, varnish or ink, many of which are comprised of polymeric materials. These materials can be applied by spraying, printing on, rolling, or dipping, or any combinations thereof. Desirably, the support material is comprised of a material different than the material of the treatment sheet. If the support material is an adhesive, it is preferable that the adhesive solidify and bond to at least a portion of a surface of the treatment sheet. The bonded area is desirably greater than half the surface of the treatment sheet (e.g., lower surface), preferably greater than 90% of the treatment sheet surface.

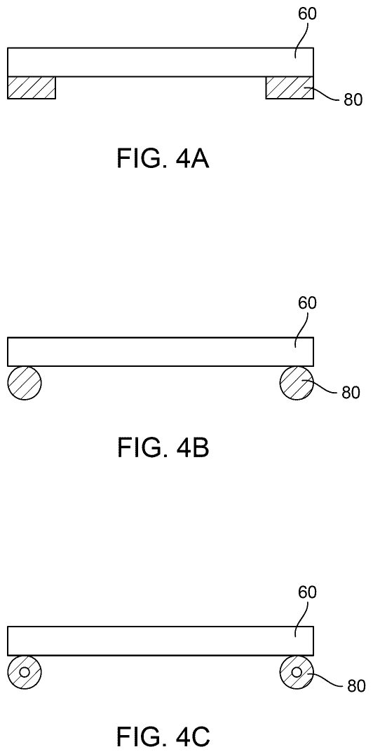

The “support structure” may also be in the form of a solid material, whereby the solid material may be provided but not limited in form of a sheet, a mesh or wires. The solid material may comprise metal, ceramic thermoplastic, thermoset, or elastomeric polymers. If applied to a surface of the treatment sheet, it is desirable that the support structure is conformal or compliant to a portion or substantially all of that surface of the treatment sheet, i.e. the support structures should be in intimate contact with the surface to the treatment sheet and follow the contours of any indentations or protrusions that may be present on the surface of the treatment sheet. Such an embodiment is shown and described related to FIG. 4A as one non-limiting example.

If the support sheet is in this form of a “layer” or a “sheet” of material then the treatment unit desirably further comprises a support material, such as an adhesive disposed between a portion of the lower surface of the treatment sheet and the upper surface of the support sheet to join or bond the support sheet to the treatment sheet. The adhesive may be provided as a separate material that is applied to either the lower surface of the treatment sheet or the upper surface of the support sheet or both prior to joining the two together or it may be provided as a layer pre-applied to the upper surface of the support sheet so that the support sheet becomes a “self-adhesive” support sheet. Such self-adhesive materials may include self-adhesive metal tapes or polymer tapes.

The treatment unit may comprise a support structure comprised of a third structure and/or material, disposed desirably at a perimeter area of the treatment sheet and/or perimeter areas of any other support structures present in the treatment unit, e.g., at the upper and lower outer perimeter areas of the treatment unit. The third support structure can be in the shape of a ring desirably in the form of an elastomer tube or flat ring. Such a ring maybe joined to an upper surface of the housing or disposed into a groove on the upper surface of the housing.

Thus, the treatment unit of the present invention comprises a treatment sheet and at least one support structure of any type. The support structure_disposed in the treatment unit of the present invention can comprise a support material, such as an adhesive or varnish, disposed under a treatment sheet, a layer or a solid support sheet, made e.g. from metal, disposed under a treatment sheet, with or without a support material (e.g., adhesive), and/or a support ring, such as an elastomeric ring, disposed at perimeter areas of a treatment sheet and/or any other support structures in the treatment unit.

Finally, the treatment unit may include any number of one or all of the above forms of the support structures in addition to the treatment sheet. Any feasible permutation of at least one support structure (e.g., support material, support sheet, or support ring) is contemplated in the present invention.

If the product is dropped with any of the treatment unit embodiments which contain at least a support ring of the present invention, the treatment sheet is prevented from cracking because the support ring reduces the force acting upon the brittle treatment sheet.

If the product is dropped with any of the treatment unit embodiments which contain a support sheet and/or a support material of the present invention, and the treatment sheet cracks, fractured pieces of the treatment sheet are held together, and the consumer is protected from injury.

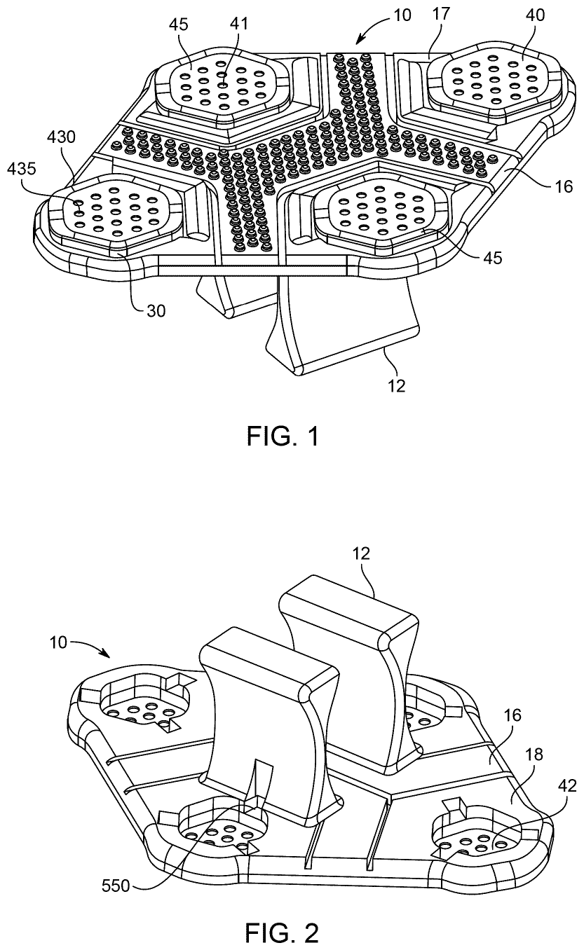

Referring to FIGS. 1-3, a shaving apparatus 10 is shown. The shaving apparatus comprises a flexible substrate 16 having a top surface 17 and a bottom surface 18. A plurality of treatment sheets 40 are secured to the flexible substrate 16. Each treatment sheet 40 comprises a plurality of first apertures 430 each of said first apertures 430 comprise cutting edges 435. The treatment sheets 40 comprise an upper surface 41, a lower surface 42 and a perimeter 45. A handle 12 is secured to the bottom surface 18 of the flexible substrate 16. The flexible substrate 16 and handle 12 allow the treatment sheets 40 to move in response to a force applied during hair removal.

The treatment sheets comprise a plurality of apertures 430. Each aperture comprises cutting edges 435. Each treatment sheet 40 comprises an upper surface 41, a lower surface 42, and a perimeter 45.

In use the user grabs the handle 12 in one hand. The user then moves the shaving apparatus across the body such that the top surface 17 of the flexible substrate contacts the skin. The cutting edges 435 of the apertures 430 cut hair as the shaving apparatus moves across the body. As the shaving apparatus moves across the contours of the skin the flexible substrate 16 moves in response to the forces being applied during hair removal. This allows the cutting edges 435 to cut body hair close to the surface of the skin.

The handle 12 may be comprised of a flexible material. Suitable flexible materials include but are not limited to fabric, rubber, silicone, polymers, metals or any combinations thereof.

The handle 12 may be comprised of rigid or semi-rigid materials. Suitable rigid or semi-rigid materials include but are not limited to rubber, silicone, polymers, metals or any combinations thereof.

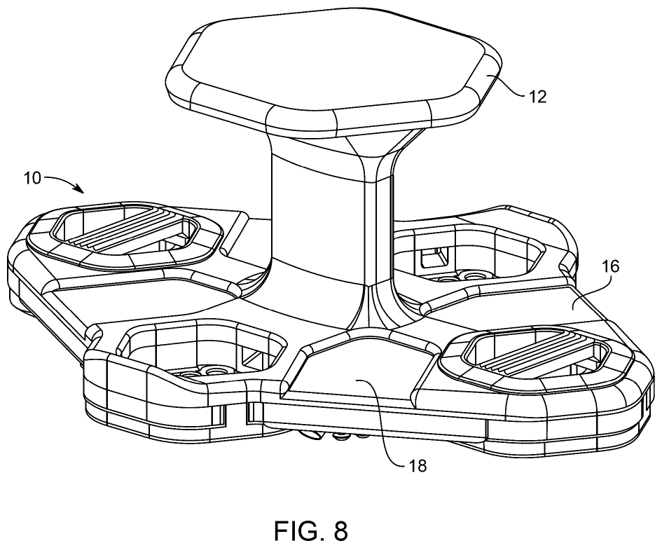

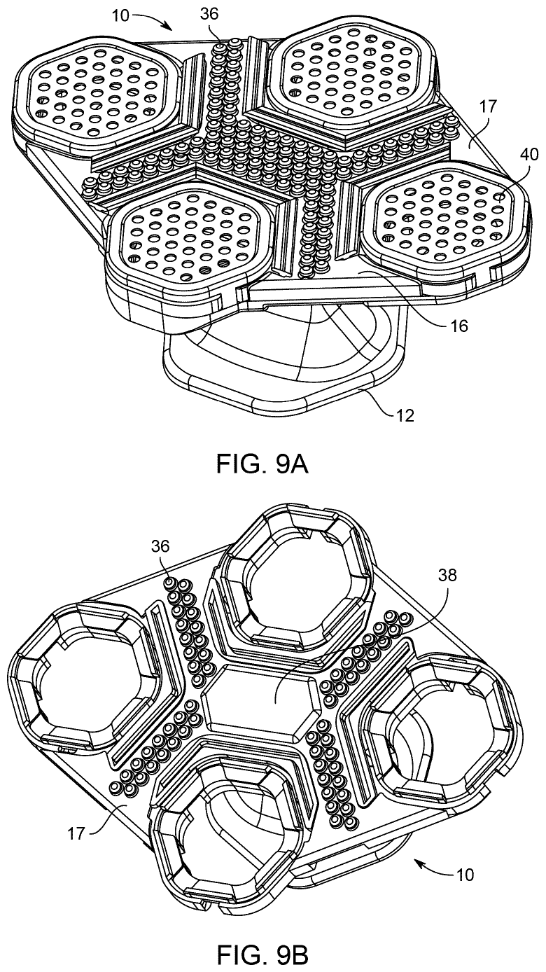

FIGS. 8 and 9A-B show alternative embodiments of the shaving apparatus 10 wherein the handle 12 comprises of a singular shape allowing for a user's fingers to fit on either side of the handle or for the user to grasp the handle 12 on the portion away from the flexible substrate 16. The user may place their fingers so that they can bend the flexible substrate 16 by applying force upon the substrate. FIG. 9A shows the top surface 17 of the flexible substrate 16. As shown in FIG. 9A, an exfoliating surface 36 may be placed between the treatment sheets 40. The exfoliating surface 36 may additionally be around one or more of the treatment sheets 40. Alternatively, as shown in FIG. 9B, all or a portion of the top surface 17 that is between the treatment sheets 40 may further comprise a chemistry 38 that can help with utilizing the product such as, for example, a lubricious chemical composition.

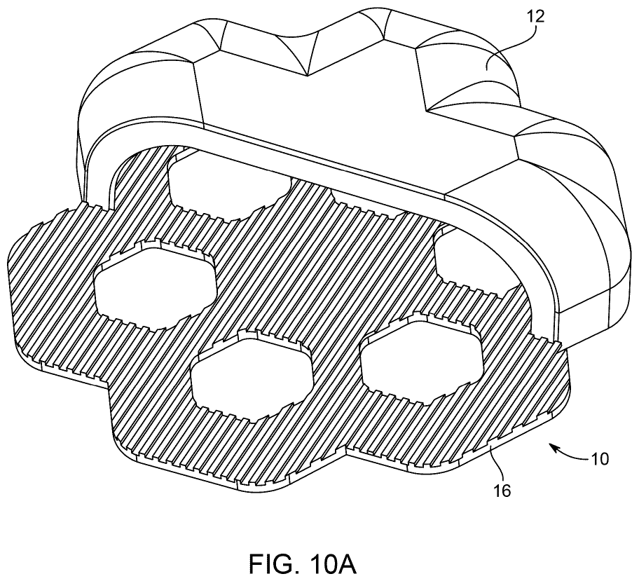

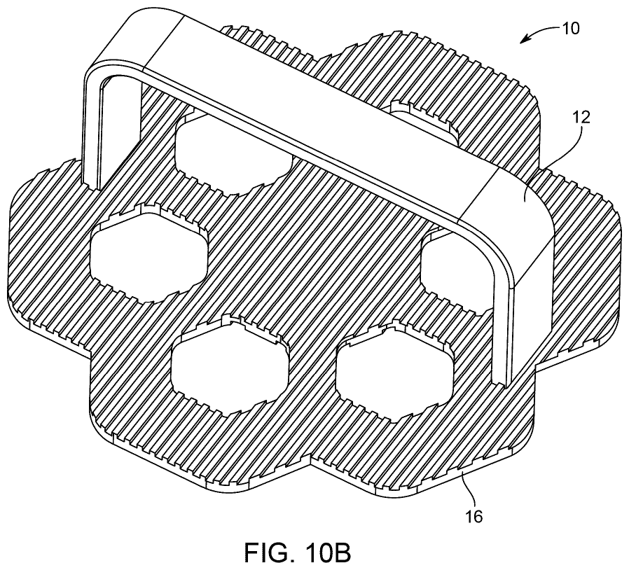

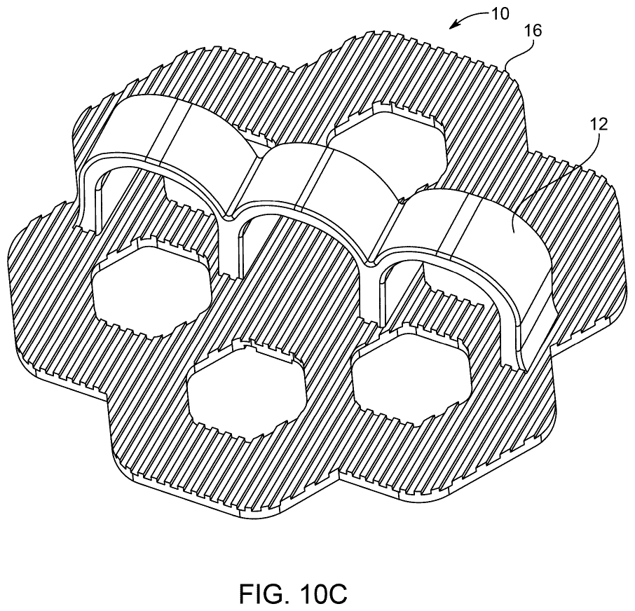

In an embodiment as shown in FIG. 10A, the handle 12 may comprise a mitt form allowing a user to insert their hand into the shaving apparatus 10. The mitt of FIG. 10A may also be a glove with individual slots for fingers. The glove may be made from the same material as the flexible substrate or a different material. In an embodiment, the flexible material which is the flexible substrate forms the portion of a glove that contacts the palm of a hand. Alternatively, as shown in 10B, the handle 12 of the shaving apparatus 10 may be formed by a material that spans from one end of the shaving apparatus to another end of the shaving apparatus such as, for example, a flexible strap, a fabric, or a polymer bar. The strap may be flexible or more rigid. The handle may incorporate the use of Velcro either as part of the strap, as a means to attach the handle, as a means to attach a handle at more than one possible orientation, and any combination thereof possible utilizing Velcro.

In an embodiment as shown in FIG. 10C, the handle 12 may be formed by various loops for fingers allowing one to slide individual fingers through designated slots.

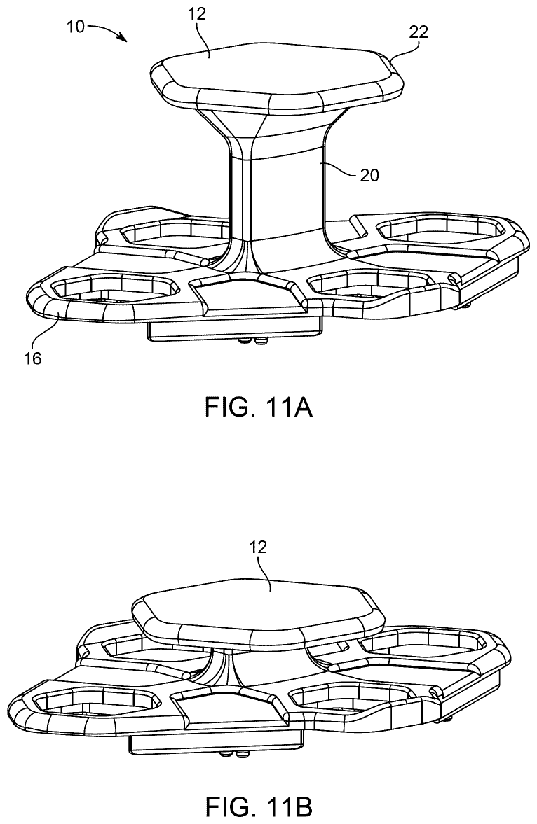

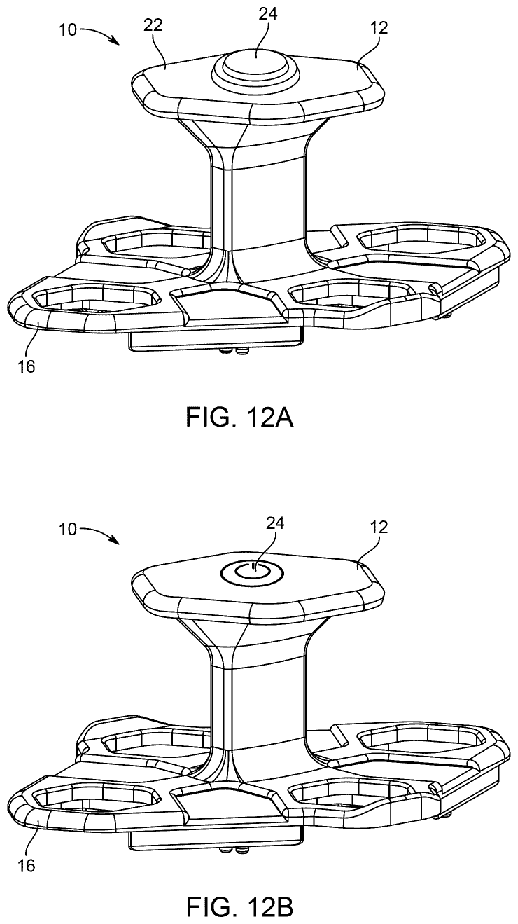

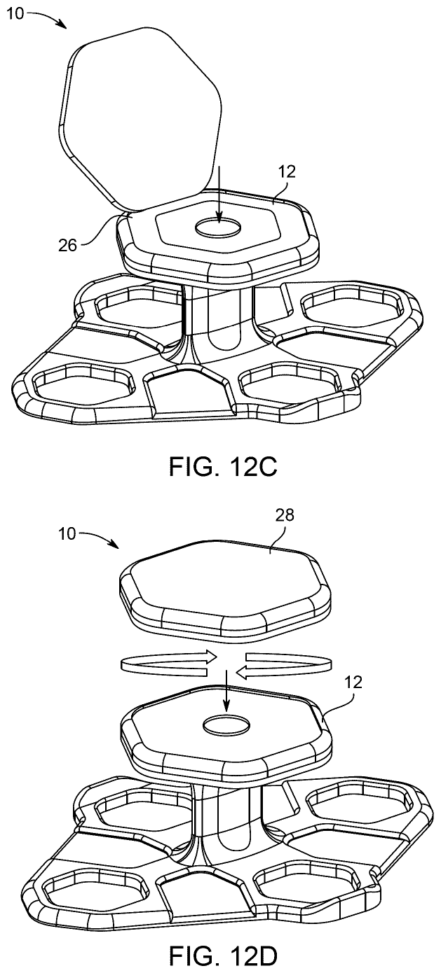

Alternatively, as shown in FIG. 11A, the handle 12 of the shaving apparatus 10 may comprise of a stem 20 and top 22. The handle may be telescopic and able to collapse on itself as shown in FIG. 11B. Alternatively, the handle may be rigid as shown in FIG. 11A. In an embodiment, the handle may be hollow and may comprise a means to distribute a shaving gel as shown in FIG. 12. The handle 12 may comprise a depressible area or button 24 that allows for a liquid or gel to be distributed to the top surface 17 of the shaving apparatus. In an embodiment, the depressible area or button 24 may be located on the stem portion of the handle or the top 22 as shown in FIG. 12A. As shown in FIGS. 12C and 12D, the handle may be filled by opening the top via either a hinge 26 as shown in FIG. 12C or a removable top 28 as shown in FIG. 12D.

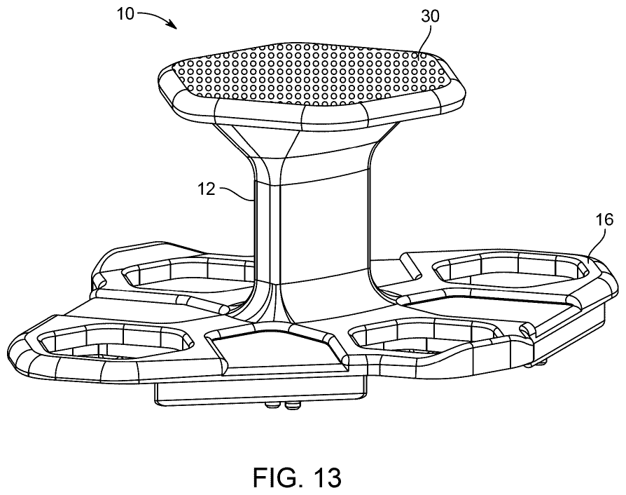

As shown in FIG. 13, the top of the handle 12 may comprise a scrubbing or exfoliating surface 30.

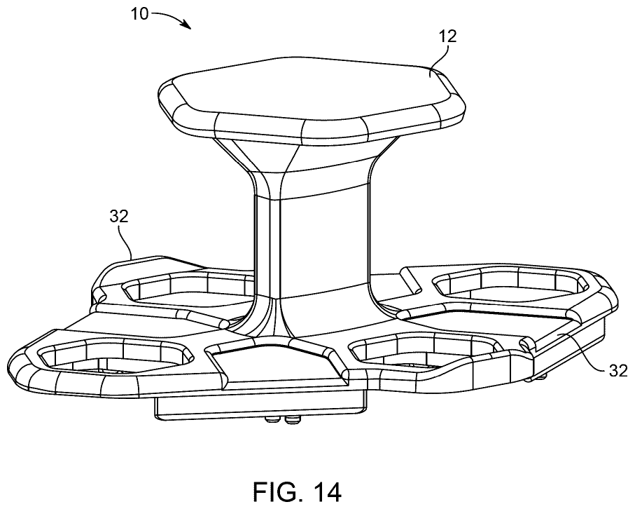

As shown in FIG. 14, the sides of the flexible substrate 16 may be raised to create an improved grip structure by adding raised edges 32.

The flexible substrate 16 may be comprised of a fabric, rubber, silicone, metal, polymer, or any combination thereof.

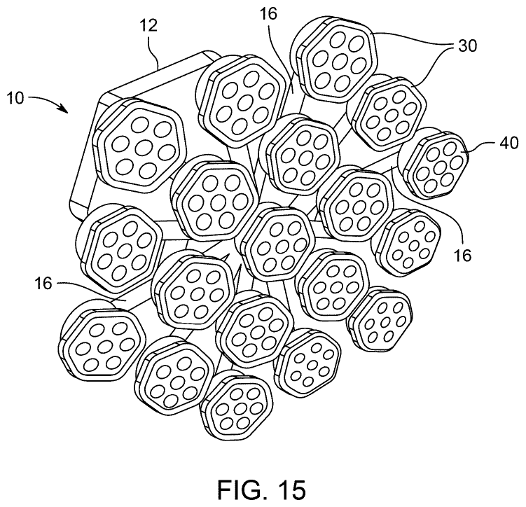

As shown in FIG. 15, the flexible substrate 16 may be a skeleton. The skeleton may have one or more treatment units 30 attached to the skeleton. As shown in FIG. 15, each portion or arm of the skeleton comprises a plurality of treatment units 30. The treatment units may be detachable from the skeleton so that they can be replaced. The treatment units may be attached to the skeleton by any form of joint known in the art including without limitation, for example, a ball and socket joint, a bolt and screw, a saddle joint, a hinge joint, a condyloid joint, and a pivot and gliding joint.

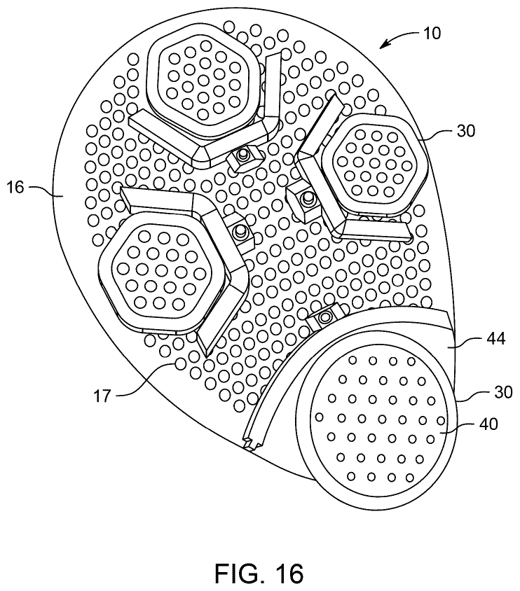

As shown in FIG. 16, the treatment units 30 may be of different dimensions and shapes. Each treatment unit may be designed with a different purpose such as to allow for greater or less control and/or to allow for a closer or less close shave. The flexible substrate may vary in thickness to change stiffness. Alternatively, as shown in FIG. 16, a different material 44 may surround one or more treatment sheets 40 such as a rigid material in the form of, e.g. a rigid plastic or metal. Alternatively, a flexible substrate may comprise more than one material wherein an additional material such as a second material may surround one or more treatment sheets having a different average stiffness while still being within the range taught herein. For example, in the shaving apparatus of FIG. 16, the flexible substrate may be thinner adjacent to the larger treatment unit to allow the user greater control and over the individual treatment unit. Additionally, by increasing flexibility in one section of the flexible substrate, the user may add more pressure on that individual unit allowing it to bend without bending the other treatment units found in the shaving apparatus. The bent individual larger treatment unit moves independently of the others while simultaneously moving with the larger group when in use as a portion of the total shaving apparatus. Without being bound by theory, it has been found that varying the average stiffness the flexible substrate around one or more treatment sheets through the use of additional materials or rigid materials allows for improved control of the individual treatment sheets thereby allowing for one to utilize variable force to reach areas with increased body contours with greater case thereby reducing accidental nicks and cuts.

The shaving apparatus may have one or more connection points that allow for additions or attachments to the shaving apparatus. The additions may be, for example, one or more treatment sheets, an attachment unit to distribute lotion while in use, a trimmer attachment, a lotion strip attachment. The attachment may be made by any known joint or attachment means know in the art including for example, without limitation, the use of slots, a ball and socket joint, or a hinge.

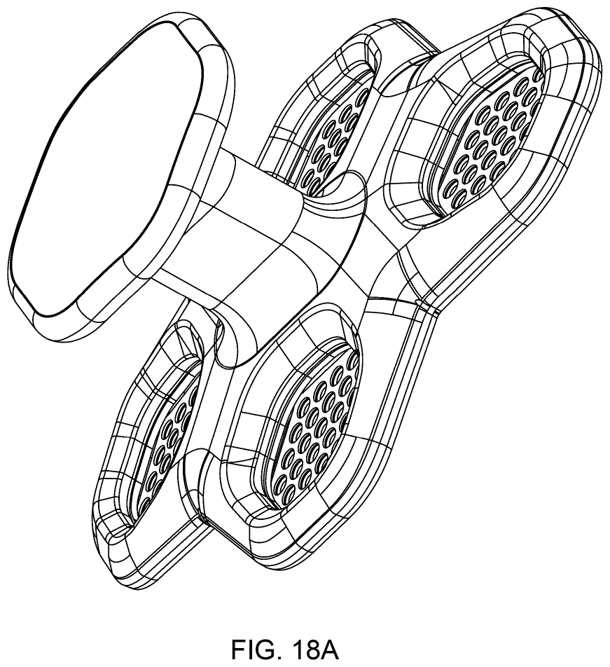

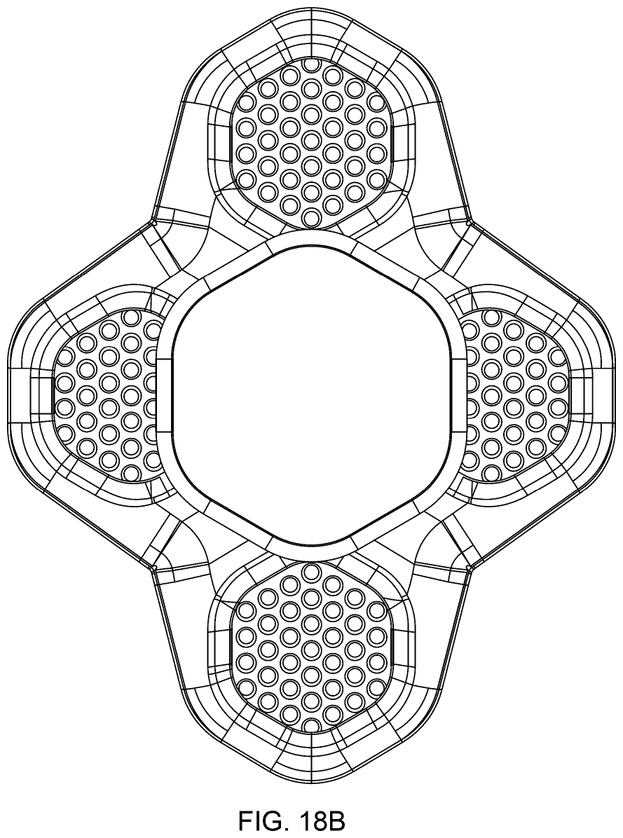

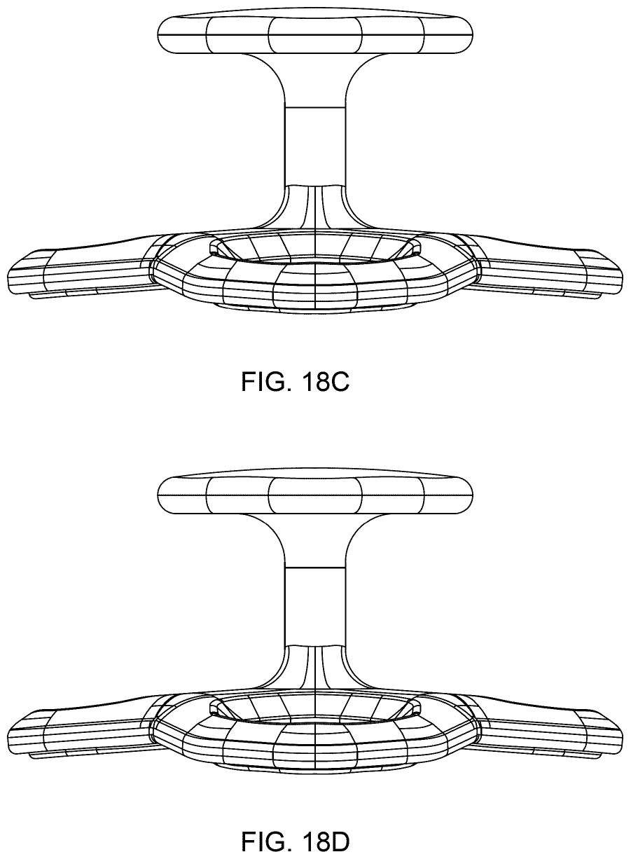

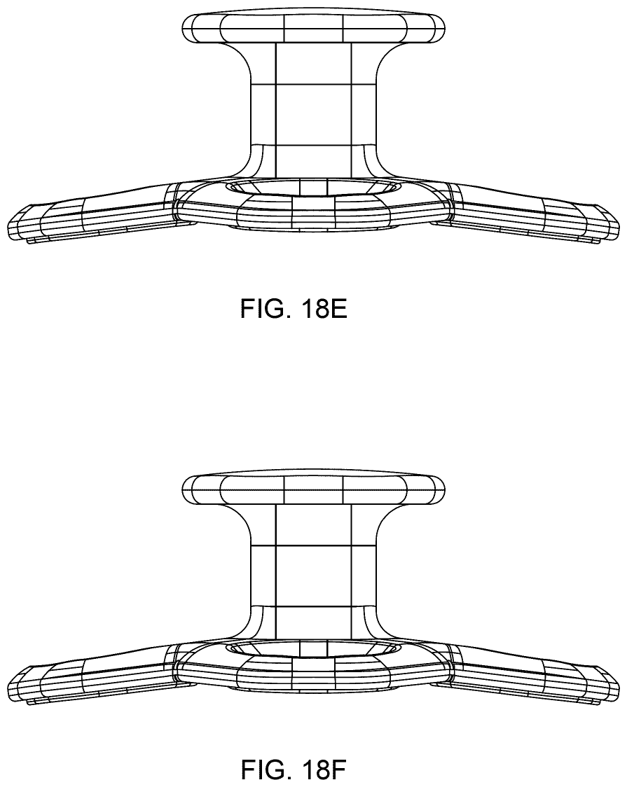

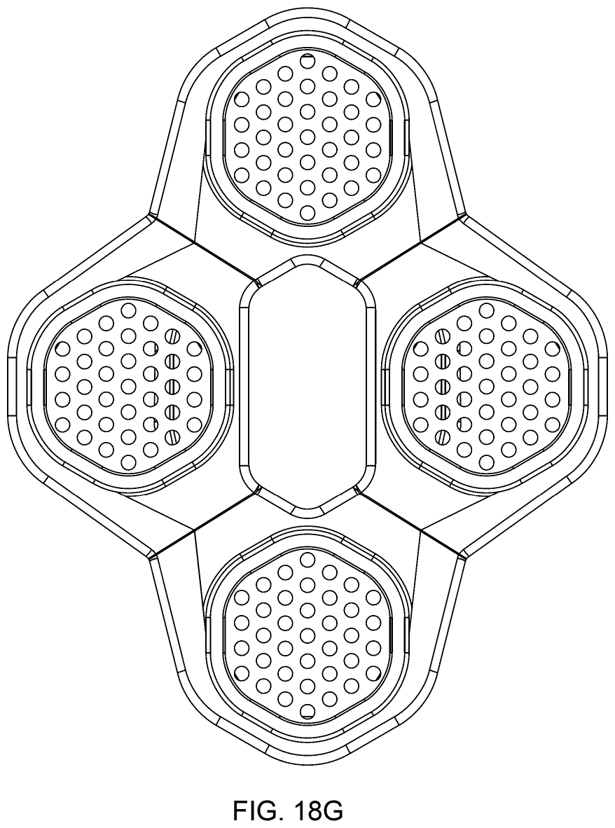

FIG. 18A-E shows different views of an embodiment where FIG. 18A shows a perspective view of an embodiment, FIG. 18B shows a top view of an embodiment, FIG. 18C shows a front view of an embodiment, FIG. 18D shows a back view of an embodiment, FIG. 18E shows a side view of an embodiment, FIG. 18F shows a side view of an embodiment, and FIG. 18G shows a bottom view of an embodiment.

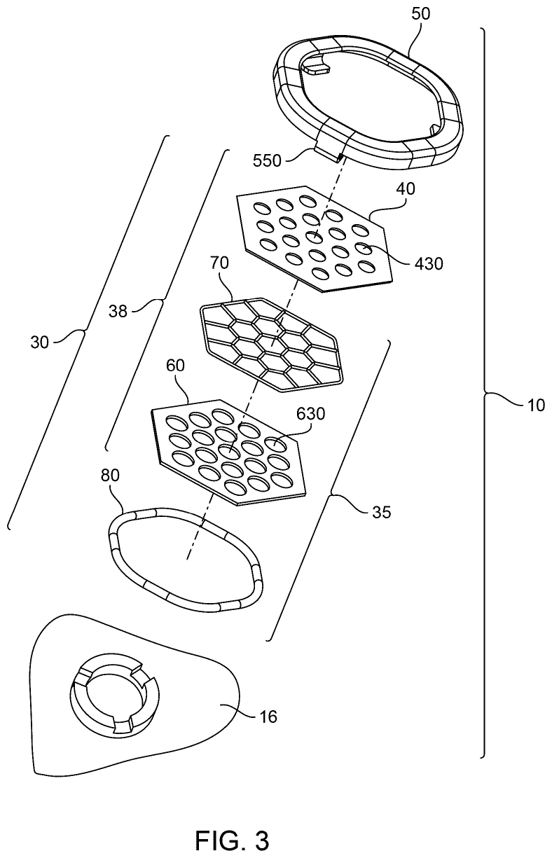

As shown in the exploded view in FIG. 3, the treatment unit 30 is comprised of a treatment sheet 40, and a support structure 35 comprised of a support sheet 60, a support material 70 and a support ring 80. While in a preferred embodiment, the support structure 35 comprises of all three of these structures shown in FIG. 3, one or two or any combination of the support sheet 60, the support material 70 and the support ring 80 are also contemplated as part of the present invention. A frame member 50, disposed over the upper surface 41 of the treatment sheet 40, is also shown, and can be utilized to hold the treatment unit in place on the flexible substrate 16. In particular, the frame member 50 may include a clip 550 that can be used to secure the treatment unit in place to the flexible substrate 16. The clip 550 may be comprised of aluminum, steel, rigid plastic, or other metal.

The treatment sheet 40 shown in FIGS. 1 and 3 has generally hexagonal shape, though any shape is contemplated in the present invention, such as, for example, triangles, squares, circles, irregular shapes, or amorphous shapes. Each treatment sheet may have a different shape within the same shaving apparatus. Two or more of the treatment sheets may have the same shape from a grouping of treatment sheets in a shaving apparatus. The treatment sheet 40 includes apertures 430 in which cutting edges 435 are formed. The cutting edges 435 in the treatment sheet function to cut and remove hair.

The support sheet 60 is disposed beneath the treatment sheet 40 and generally has the same shape as the treatment sheet, e.g., hexagonal in the present invention, though any shape is contemplated. The support sheet 60 comprises apertures 630 that generally line up beneath the apertures 430 of the treatment sheet, however unlike those of the treatment sheet, the apertures of the support sheet do not comprise cutting edges. This alignment provides for a flow path into the cavity of the housing for debris removal. Generally, the apertures of the support sheet 60 are larger than the apertures of the treatment sheet 40. When viewing the treatment sheet directly from the top the support sheet and other support structures of the support structure 35 are desirably not visible.

The support material 70 is generally sprayed, brushed, rolled, dipped, taped, or printed on the lower surface of treatment sheet 40.

If the shaving apparatus is accidentally dropped, support sheet 60 and/or support material 70 are protecting the treatment sheet such that any fragments that may break loose from the brittle material of the treatment sheet are held together.

As shown in FIGS. 4A to 4C, the support ring 80 is shown disposed under the perimeter area of the support sheet 60. The ring is desirably in the form of a flattened ring, a solid tube, a hollow tube, or any portions or combinations made from a thermoplastic, thermoset, or elastomeric polymer.

The support ring may be disposed under, above or around the treatment sheet 40 or the support material 70 joined to the treatment sheet 40 or the support sheet 60 joined to the treatment sheet 40.

If the shaving apparatus is dropped, this support ring 80 protects the treatment sheet 40 by reducing any forces that may act upon the treatment sheet thus reducing damage to the treatment sheet (e.g., reduced fractures, reduced fragments breaking off from the treatment sheet) and preventing injury to the consumer.

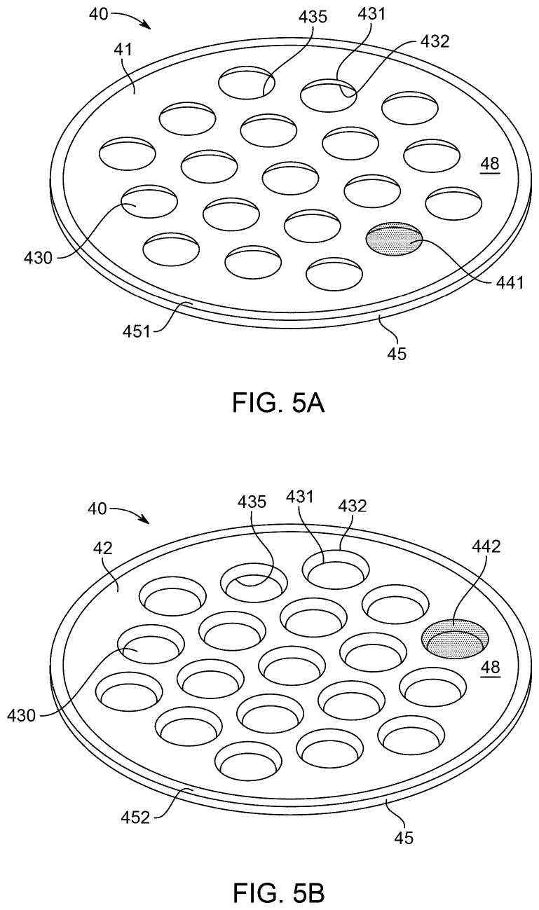

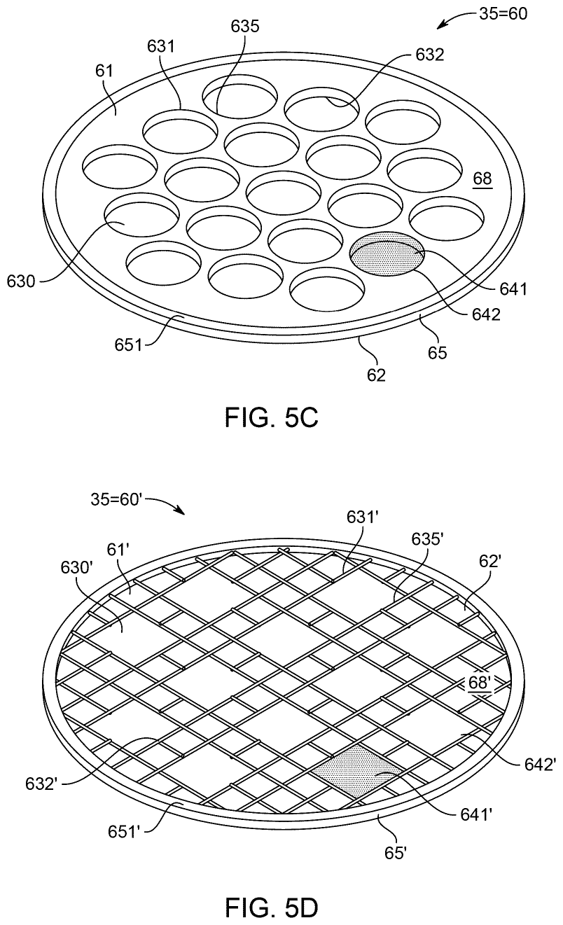

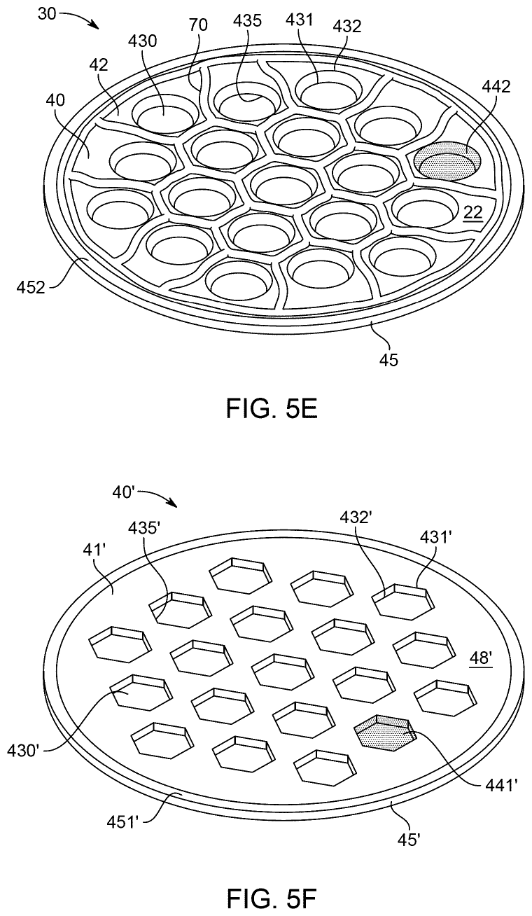

In FIGS. 5A and 5B, an upper surface 41 and a lower surface 42 of a treatment sheet 40 are shown respectively. Substrate 48 of treatment sheet 40 comprises at least one material, preferably silicon or ceramic, and as noted above, comprises apertures 430 with cutting edges 435 along upper inner perimeters 431 of the apertures 430 on the upper surface 41. The cutting edges 435 of the apertures 430 are coplanar (e.g., do not protrude from) with the upper surface 41. A lower inner perimeter 432 and a lower aperture area 442 on the lower surface 42 may be desirably the same or greater than the upper inner perimeter 431 and the upper aperture area 441 on the upper surface 41, (e.g., as also shown in FIGS. 5A and 5B), allowing for debris (cut hairs, skin cells and treatment aids) to fall through easily once removed from the skin of a user.

In FIG. 5C, an upper surface 61 of a support sheet 60 is shown. Substrate 68 of support sheet 60 comprises at least one material, preferably a hard plastic or metal and as noted above, comprises apertures 630 with non-cutting edges 635 along the upper inner perimeters 631 of the apertures 630. The non-cutting edges 635 of the apertures 630 are coplanar (e.g., do not protrude from) with the upper surface 61. A lower surface 62 comprises substantially the same features as the upper surface 61. The upper inner perimeter 631 of the apertures 630 and an upper aperture area 641 formed at the upper surface 61 are desirably about the same or slightly smaller than a lower inner perimeter 632 and a lower aperture area 642 formed at the lower surface 62 (not shown), and both first and second apertures areas 641 and 642 are desirably equal to or greater than the lower aperture area 442 of the treatment sheet 40, thereby also allowing for debris (cut hairs, skin cells, treatment aids) to fall through easily once removed from the skin of a user.

In FIG. 5D, an upper surface 61′ of an alternate embodiment of a support sheet 60′ in a treatment unit of the present invention is shown. Here, substrate 68′ of support sheet 60′ comprises a mesh or wire type of material. A mesh type of material is itself comprised of a plurality of small apertures. However, the mesh material can include larger apertures 630′ with non-cutting edges 635′ along the perimeters of the apertures 630′. The non-cutting edges 635′ of the apertures 630′ are coplanar (e.g., do not protrude from) with the upper surface 61′. The upper inner perimeter 631′ of the apertures 630′ and upper aperture area 641′ formed at the upper surface 61′ are desirably about the same or slightly less than the lower inner perimeter 632′ and lower aperture area 642′ formed at the lower surface 62′, and both first and inner perimeters 631′ and 632′ are desirably equal to or greater than the lower inner perimeter 432 of the treatment sheet 40, thereby also allowing for debris (cut hairs, skin cells and treatment aids) to fall through easily once removed from the skin of a user.

In FIG. 5E, an alternate embodiment of a treatment unit 30 of the present invention depicts a support material 70 joined to the lower surface 42 of treatment sheet 40. Here, support material 70 comprises an adhesive, a varnish or ink layer directly applied and bonded to the lower surface of the treatment sheet 40, desirably not covering the apertures 430 of treatment sheet 40. The support material 70 can be any type of fluid material which cures or hardens with heat, light and/or time, like an adhesive, varnish or ink that may be initially a fluid, but will dry or cure to form a solid material.

In one embodiment of the present invention, the support sheet 60 is comprised of stainless steel having a thickness of between 0.1 to 1 mm, desirably about 0.30 to 0.5 mm.

The support material may comprise of adhesive, varnish or ink which will be initially applied as a fluid and subsequently dry or cure to form a solid material. In this way, support material is protecting the treatment sheet such that any fragments that may break loose from the brittle material of the treatment sheet when the personal care product is accidentally dropped are held together.

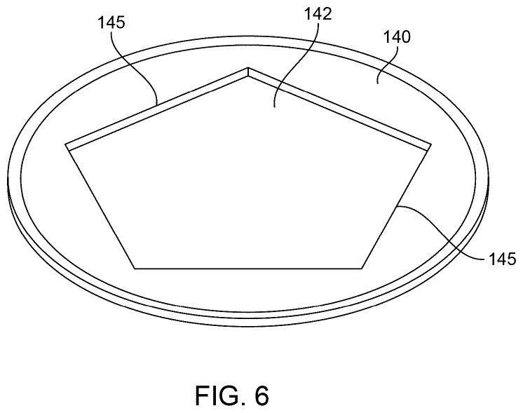

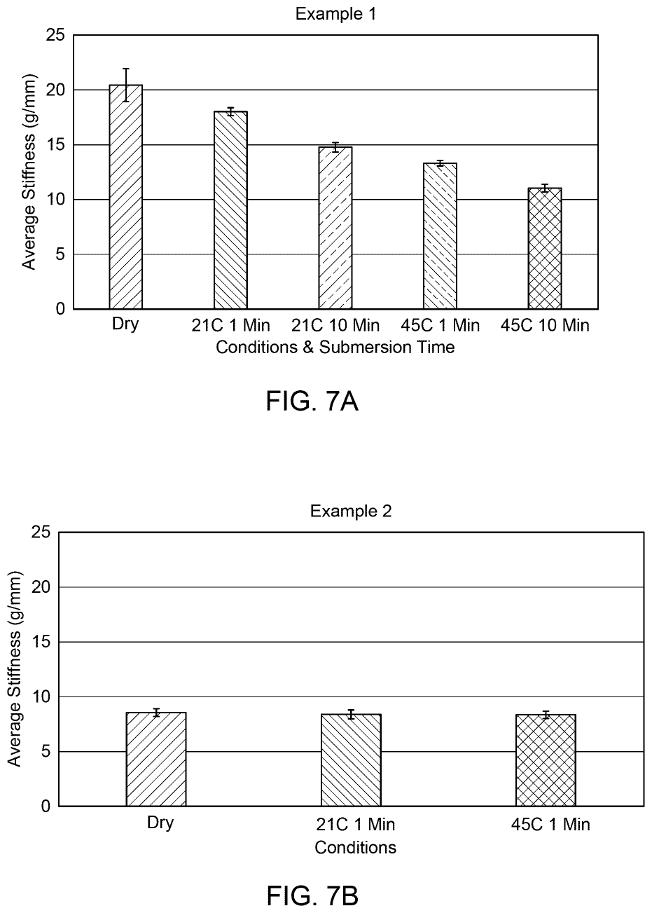

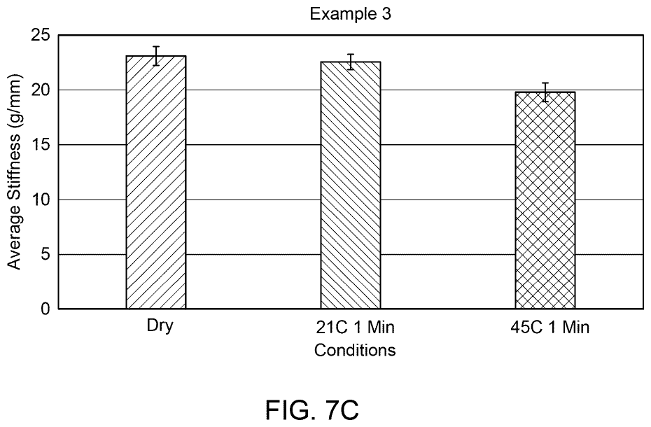

Referring now to FIG. 6 there is shown another treatment sheet 140 of the present invention. Treatment sheet 140 comprises a single first aperture 142. Aperture 142 comprising cutting edges 145. The shaving apparatus of the present invention may comprise treatment sheets 140. The shaving apparatus of the present invention may comprise treatment sheets 40 as shown in FIG. 1. The shaving apparatus of the present invention may comprise a combination of treatment sheets 40 and 140.

### Test Methods:

Stiffness may be measured utilizing an Instron ‘Universal testing system’. To test the shaving apparatus support sheet, one may follow the steps found herein. First, power on the Instron frame and login to the workstation. Start Instron software and press ‘Test’. Next, use the Instron software to program the frame to displace the probe 13 mm at 1 mm/s. Use a 10 mm diameter metal, roundhead probe on the 100N Load cell attached to the Instron frame arm.

Once the Instron “Universal Testing System is prepared, then prepare sample for testing depending on the run conditions:

| Condition | Hydration Time | Temperature |
|---|---|---|
| Dry | Sample is not | Sample is kept at room |
| | hydrated | temperature of 21° C. |
| 21° C. | Sample completely | Sample is submerged |
| for 1 min | submerged in beaker | in 500 ml of water, |
| | for one minute | controlled by a |
| | | hotplate with |
| | | thermometer at 21° C. |
| 45° C. | Sample completely | Sample is submerged |
| for 1 min | submerged in beaker | in 500 ml of water, |
| | for one minute | controlled by a |
| | | hotplate with |
| | | thermometer at 45° C. |
| 21° C. | Sample completely | Sample is submerged |
| for 10 mins | submerged in beaker | in 500 ml of water, |
| | for ten minutes | controlled by a |
| | | hotplate with |
| | | thermometer at 21° C. |
| 45° C. | Sample completely | Sample is submerged |
| for 10 mins | submerged in beaker | in 500 ml of water, |
| | for ten minutes | controlled by a |
| | | hotplate with |
| | | thermometer at 45° C. |

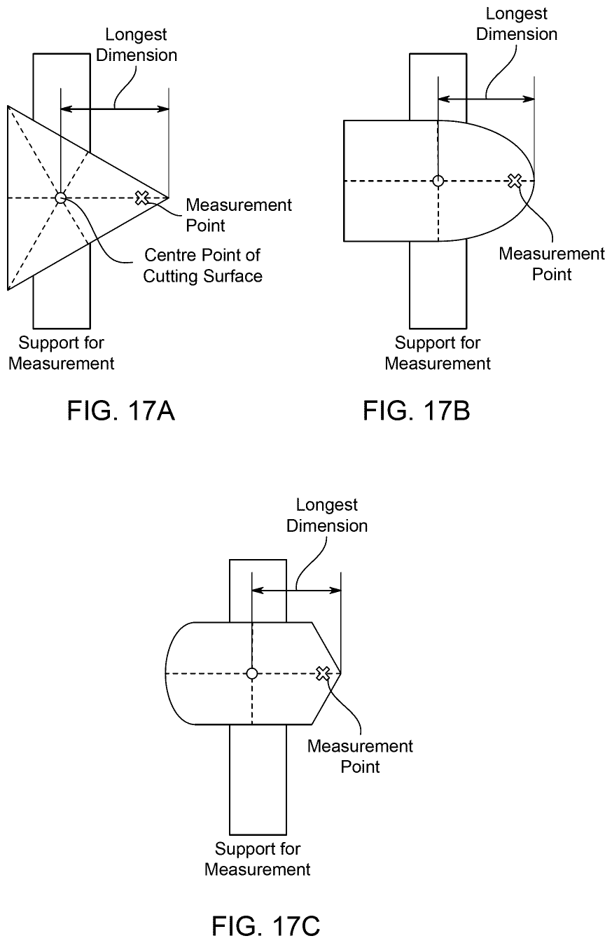

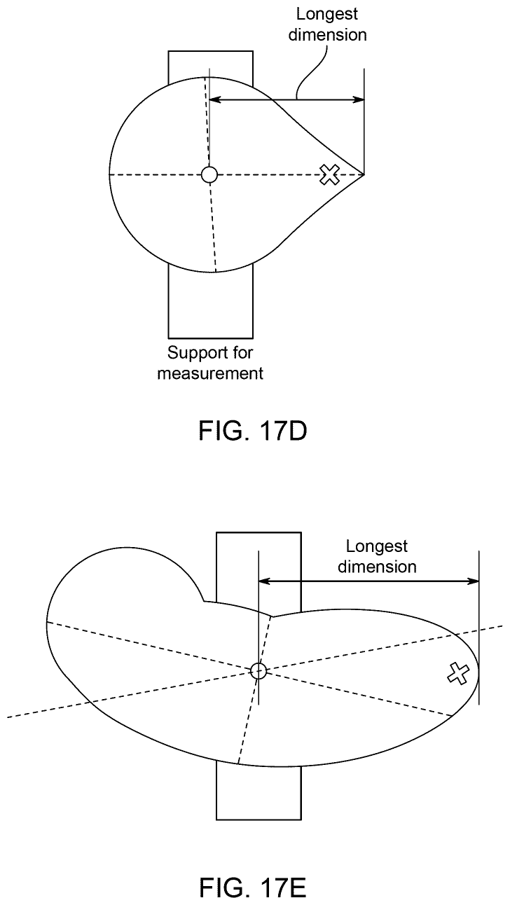

Once a sample has been properly prepared, place the sample mounting block between the vice, ensuring it has 15 mm of space between the lip of the vice and the base of the sample and tighten, ensuring the sample has minimal movement, but the Elastomer housing of the shaving apparatus should be able to tilt. Next, adjust the stage to position the probe so it will contact the point between the edge of the shaving apparatus and where the edge of the insert is. The shaving apparatus sample should be set up so that the probe touches near an edge at the end of the larger perimeter end to end measurement of the shaving apparatus when crossing through the center of the shaving apparatus. The point of contact of the probe may vary depending on the geometry. FIG. 17A-E shows preferred measurement points for various types of possible shapes. Use the controller on the side of the Instron to jog the probe so it's just above the point adjacent inward to the edge of the sample. No force should be being applied to the sample nor should it be detected on the controller.

Once in the correct position, zero the force and displacement distance on the Instron software. The displacement distance should read 0 mm and the force display should be between −0.1 gf and 0.1 gf. Press “start” and the Instron will displace the sample 13 mm. The probe will return to its starting position once testing has completed. Repeat the process to get at least 3 measurements. Repeat on the opposite side. Total of 6 runs per sample or shaving apparatus.
A. A shaving apparatus having a flexible substrate; and a plurality of treatment sheets each treatment sheet comprising at least one first aperture, at least one first aperture comprising cutting edges, wherein the plurality of treatments sheet are secured to said flexible substrate.
B. The shaving apparatus of paragraph A, wherein the shaving apparatus further comprises a handle being secured to a bottom surface of said flexible substrate, wherein said flexible substrate and said handle allow said treatment sheets to move in response to a force applied during hair removal.
C. The shaving apparatus of any of paragraph's A to B, further comprising a support sheet joined to a lower surface of said treatment sheet, an upper surface of said treatment sheet, or any combination thereof.
D. The shaving apparatus of any of paragraph C, wherein the support sheet is compliant along at least a portion of a lower surface of said treatment sheet.
E. The shaving apparatus of any of paragraphs C to D, wherein the support sheet does not obstruct the plurality of said first apertures.
F. The shaving apparatus of any of paragraphs C to E, wherein said support sheet comprises a solid material which is comprised of a metal, ceramic, thermoplastic, thermoset, or elastomeric polymer.
G. The shaving apparatus of any of paragraphs C to F, wherein said support sheet comprises a plurality of second apertures.
H. The shaving apparatus of paragraph G, wherein each of said plurality of second apertures are aligned with each of said plurality of first apertures.
I. The shaving apparatus of any of paragraphs C to H, wherein said support sheet is joined to said treatment sheet by a support material.
J. The shaving apparatus of paragraph I, wherein said support material is an adhesive, a varnish, an ink, or any combination thereof.
K. The shaving apparatus of any of paragraphs A-J, wherein said treatment sheet is secured directly to said flexible substrate.
L. The shaving apparatus of any of paragraphs A-K, wherein said treatment sheet is secured indirectly to said flexible substrate.
M. The shaving apparatus of paragraph L, further comprising a support ring being secured to each treatment sheet, said support ring being secured to said flexible substrate.
N. The shaving apparatus of paragraph M, wherein said support ring is comprised of a thermoplastic, thermoset, elastomeric polymer, or any combination thereof.
O. The shaving apparatus of any of paragraphs M to N, wherein said support ring is comprised of a flattened ring, a solid tube, a hollow tube, or any portions or combinations thereof.
P. The shaving apparatus of any of paragraphs B to O, wherein said handle is comprised of a flexible material.
Q. The shaving apparatus of any of paragraphs B to P, wherein said handle is comprised of a rigid material.
R. The shaving apparatus of any of paragraphs A to Q, wherein the flexible substrate is comprised of a fabric, rubber, silicone, polymer, or any combination thereof.
S. The shaving apparatus of any of paragraphs A to R, further comprising a clip securing the treatment sheet to said flexible substrate.
T. The shaving apparatus of paragraph S, wherein the clip is comprised of aluminum or steel.
U. The shaving apparatus of any of paragraphs A to T, wherein the support sheet exhibits an average stiffness (g/mm) when dry between 5 g/mm and 20 g/mm.
V. The shaving apparatus of any of paragraph A to U, wherein the support sheet exhibits an average stiffness of less than 10 g/mm when wet.

The illustrations presented herein are not intended to be actual views of any particular substrate, apparatus (e.g., device, system, etc.), or method, but are merely idealized and/or schematic representations that are employed to describe and illustrate various embodiments of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” The term “about” as used herein generally signifies approximately or around. As one example, when a range of numerals are given, e.g., if “about 4 to about 40” is or “4 to 40” is disclosed herein, the present invention contemplates the recited value of “4” and “40” and a functionally equivalent range surrounding each of the 4 and the 40, which can generally be plus or minus 10 percent of each number. Thus, for clarity, if a reference is described as being “4 to 40” this signifies it could be a functionally equivalent range of 4 and a functionally equivalent range of 40 or “about 4 to about 40.” The latter signifies the range of “3.6 to 44” as being encompassed by the present invention since the range of 3.6 to 4.4 represents plus and minus 10 percent of 4, respectively and the range of 36 to 44 represents plus and minus 10 percent of 40, respectively.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover, in the appended claims, all such changes and modifications that are within the scope of this invention.

What is claimed is:

1. A shaving apparatus comprising:
a flexible substrate; and
a plurality of treatment sheets each treatment sheet comprising at least one first aperture, at least one first aperture comprising cutting edges, wherein the plurality of treatments sheet are secured to said flexible substrate.

2. The shaving apparatus of claim 1, wherein the shaving apparatus further comprises a handle being secured to a bottom surface of said flexible substrate, wherein said flexible substrate and said handle allow said treatment sheets to move in response to a force applied during hair removal.

3. The shaving apparatus of claim 1, further comprising a support sheet joined to a lower surface of said treatment sheet, an upper surface of said treatment sheet, or any combination thereof.

4. The shaving apparatus of claim 3, wherein the support sheet is compliant along at least a portion of a lower surface of said treatment sheet.

5. The shaving apparatus of claim 3, wherein the support sheet does not obstruct the plurality of said first apertures.

6. The shaving apparatus of claim 3, wherein said support sheet comprises a solid material which is comprised of a metal, ceramic, thermoplastic, thermoset, or elastomeric polymer.

7. The shaving apparatus of claim 3, wherein said support sheet comprises a plurality of second apertures.

8. The shaving apparatus of claim 7, wherein each of said plurality of second apertures are aligned with each of said plurality of first apertures.

9. The shaving apparatus of claim 3, wherein said support sheet is joined to said treatment sheet by a support material.

10. The shaving apparatus of claim 9, wherein said support material is an adhesive, a varnish, an ink, or any combination thereof.

11. The shaving apparatus of claim 1, wherein said treatment sheet is secured indirectly to said flexible substrate.

12. The shaving apparatus of claim 11, further comprising a support ring being secured to each treatment sheet, said support ring being secured to said flexible substrate.

13. The shaving apparatus of claim 12, wherein said support ring is comprised of a thermoplastic, thermoset, elastomeric polymer, or any combination thereof.

14. The shaving apparatus of claim 12, wherein said support ring is comprised of a flattened ring, a solid tube, a hollow tube, or any portions or combinations thereof.

15. The shaving apparatus of claim 2, wherein said handle is comprised of a flexible material.

16. The shaving apparatus of claim 2, wherein said handle is comprised of a rigid material.

17. The shaving apparatus of claim 1, wherein the flexible substrate is comprised of a fabric, rubber, silicone, polymer, or any combination thereof.

18. The shaving apparatus of claim 1, further comprising a clip securing the treatment sheet to said flexible substrate.

19. The shaving apparatus of claim 1, wherein the flexible substrate exhibits an average stiffness (g/mm) when dry between 5 g/mm and 20 g/mm.

20. The shaving apparatus of claim 1, wherein the flexible substrate sheet exhibits an average stiffness of less than 10 g/mm when wet.
